(19) United States
(12) Patent Application Publication
(10) Pub. No.: US 2013/0057819 A1
(43) Pub. Date: Mar. 7, 2013

(54) LIQUID CRYSTAL DISPLAY ELEMENT

(71) Applicants: Yoshihisa KUROSAKI, Setagaya (JP); Toshiaki Yoshihara, Sagamihara (JP)

(72) Inventors: Yoshihisa KUROSAKI, Setagaya (JP); Toshiaki Yoshihara, Sagamihara (JP)

(73) Assignee: FUJITSU LIMITED, Kawasaki-shi (JP)

(21) Appl. No.: 13/589,401

(22) Filed: Aug. 20, 2012

(30) Foreign Application Priority Data
Sep. 2, 2011 (JP) 2011-191848

(51) Int. Cl. G02F 1/1339

(52) U.S. Cl. 349/154

(57) ABSTRACT

A liquid crystal display element includes a flexible first substrate and second substrate, an inter-substrate spacer structure that bonds the first substrate and the second substrate and keeps a space between the two substrates at a certain interval, a seal material that seals a surrounding area between the two substrates to form a cell space, a liquid crystal that is injected in the cell space, and an injection hole that is formed between the two substrates for injecting the liquid crystal from an outside into the cell space, the injection hole including an injection hole spacer structure that keeps the space between the two substrates at a certain interval.

### CROSS-REFERENCE TO RELATED APPLICATION

This application is based upon and claims the benefit of priority of the prior Japanese Patent Application No. 2011-191848, filed on Sep. 2, 2012, the entire contents of which are incorporated herein by reference.

### FIELD

The embodiment discussed herein is related to a liquid crystal display element.

### BACKGROUND

For producing a liquid crystal display element, two substrates on which transparent electrodes are formed are stuck to each other at a uniform interval (gap) such that the transparent electrodes face each other, a seal material is provided at the peripheries of the two substrates so as to form a sealed cell space between the two substrates, and a liquid crystal is injected into the cell space. In order to keep the gap uniform, bead spacers or columnar spacers formed by photolithography or the like are provided between the two substrates. A portion of the seal material forms an injection hole for injecting the liquid crystal, and the liquid crystal is injected into the cell space through the injection hole by a vacuum pumping method. The injection hole is sealed by a sealant after completion of the injection of the liquid crystal.

In recent years, bendable liquid crystal display elements have been developed in which flexible resin substrates (film substrates) are used instead of glass substrates, and furthermore adhesive columnar spacers are used in order to keep gaps even when the elements are bent.

In the case where flexible film substrates are used, during manufacturing of an element, an injection hole may be narrowed or closed due to contact or the like of the film substrates with each other at an injection hole portion, and the two film substrates may be separated from each other during injection of a liquid crystal. In order to address such a problem, columnar spacers are provided at the injection hole portion. The shapes and arrangement interval of the columnar spacers are determined such that the injection hole is not narrowed and closed and such that flow of gas, the liquid crystal, and a sealant between the cell space and the outside is made easy. In other words, if the interval between the columnar spacers is decreased, the injection hole is unlikely to be narrowed and closed even when the film substrates are bent, but the flow of the gas, the liquid crystal, and the sealant through the injection hole is impaired. Thus, the shapes and arrangement interval of the columnar spacers are preferably determined in consideration of two conditions of: narrowing and closing of the injection hole; and flow of the gas, the liquid crystal, and the sealant.

Various examples of the shapes and arrangement of columnar spacers used at the injection hole portion have been proposed but there is no example that meets the above two conditions. Japanese Laid-open Patent Publication No. 2008-242150, Japanese Laid-open Patent Publication No. 59-191014, Japanese Laid-open Patent Publication No. 2008-225002, Japanese Laid-open Patent Publication No. 2006-243658, and International Publication Pamphlet No. WO2007/007394 are examples of the related art.

### SUMMARY

According to an aspect of the invention, a liquid crystal display element includes a flexible first substrate and a flexible second substrate, an inter-substrate spacer structure that bonds the first substrate and the second substrate and keeps a space between the first substrate and the second substrate at a certain interval, a seal material that seals a surrounding area between the first substrate and the second substrate to form a cell space, a liquid crystal that is injected in the cell space, and an injection hole that is formed between the first substrate and the second substrate for injecting the liquid crystal from an outside into the cell space and includes an injection hole spacer structure that keeps the space between the first substrate and the second substrate at a certain interval, the injection hole spacer structure including a plurality of lines which each line includes of a plurality of extending structures that are arranged such that extending directions of the plurality of extending structures are parallel to each other when the plurality of extending structures are seen from a direction perpendicular to the first and second substrates, wherein in each line, the plurality of extending structures are arranged at a certain interval, and the plurality of extending structures in adjacent lines are arranged such that the extending direction of the plurality of extending structures in one of the lines does not overlap the extending direction of the plurality of extending structures in the other line.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a general liquid crystal display element;

FIG. 2 is a diagram illustrating a method for manufacturing the liquid crystal display element in FIG. 1;

FIGS. 3A and 3B are diagrams illustrating cross sections of a bendable liquid crystal display element, in which an upper substrate and a lower substrate are formed as flexible film substrates, in a normal state and a bent state, respectively;

FIGS. 4A to 4C are diagrams illustrating an example of columnar spacers (spacer structures);

FIG. 5 is a diagram illustrating in detail the relationship between the columnar spacers and strip electrodes on the upper and lower substrates;

FIGS. 6A and 6B are diagrams explaining a vacuum pumping method and illustrate a case where a liquid crystal is injected into a liquid crystal panel by the vacuum pumping method;

FIGS. 7A to 7E are diagrams explaining a method for sealing an injection hole;

FIGS. 8A and 8B are diagrams explaining a problem arising during injection of a liquid crystal by the vacuum pumping method in a case where an injection hole is too narrow;

FIGS. 9A to 9F are diagrams explaining a problem arising in a case where cylindrical spacers are regularly arranged at an injection hole portion;

FIG. 10 is a diagram explaining an example and its problem of a plurality of columnar spacers that are proposed in order to alleviate closing of an injection hole by bending of film substrates and that extend in a direction connecting the outside and a cell space and are arranged so as to be parallel to each other;

FIGS. 11A and 11B are diagrams illustrating the shapes and arrangement of columnar spacers at an injection hole portion of a liquid crystal display element according to an embodiment; and

FIGS. 12A to 12D are diagrams illustrating various modified examples of the shapes and arrangement of the columnar spacers.

### DESCRIPTION OF EMBODIMENT

Prior to describing an embodiment, the structure of a general liquid crystal display element and a method for manufacturing the element will be described.

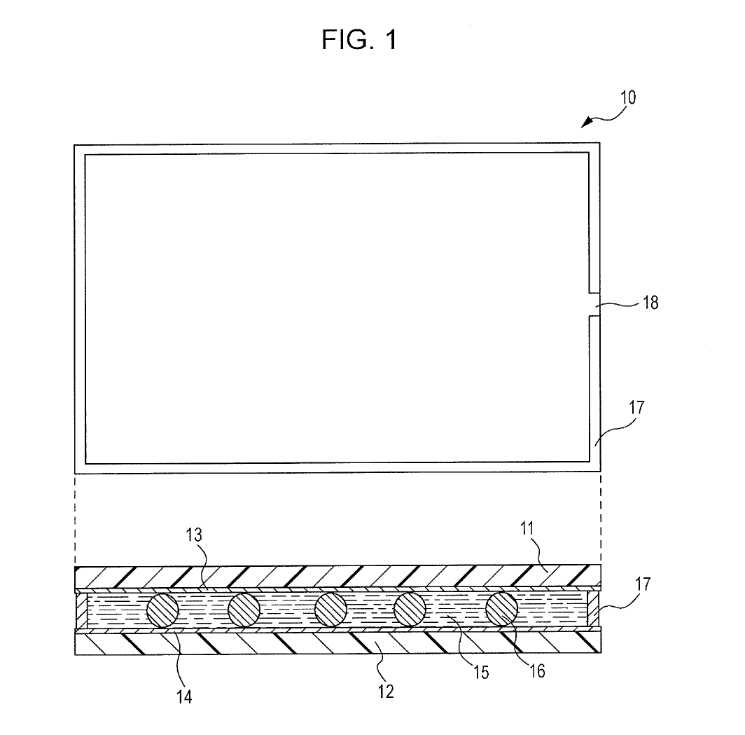

FIG. 1 is a diagram illustrating the configuration of a general liquid crystal display element. As illustrated as FIG. 1, the liquid crystal display element 10 includes a first substrate (upper substrate) 11, a second substrate (lower substrate) 12, bead spacers 16 that define an interval (gap) between the upper substrate 11 and the lower substrate 12, and a seal material 17 provided at a peripheral portion between the upper substrate 11 and the lower substrate 12. Layers 13 and 14 including transparent electrodes, alignment films, and the like are formed on the facing surfaces of the upper substrate 11 and the lower substrate 12. The seal material 17 seals a cell space between the upper substrate 11 and the lower substrate 12 from the outside. The bead spacers 16 are located within the cell space. The seal material 17 has an injection hole 18 which is an opening. A liquid crystal 15 is injected into the cell space between the stuck upper substrate 11 and the lower substrate 12 through the injection hole 18 by, for example, a “vacuum pumping method”. The bead spacers 16 are, for example, spheres having diameters of 5 μm and are applied onto the lower substrate 12. Then, the upper substrate 11 is placed on the lower substrate 12 to stick the two substrates 11 and 12 together. Thus, a gap is kept at 5 μm over the entire surfaces of the substrates 11 and 12. After the injection of the liquid crystal 15 is completed, the injection hole 18 is sealed by a sealant.

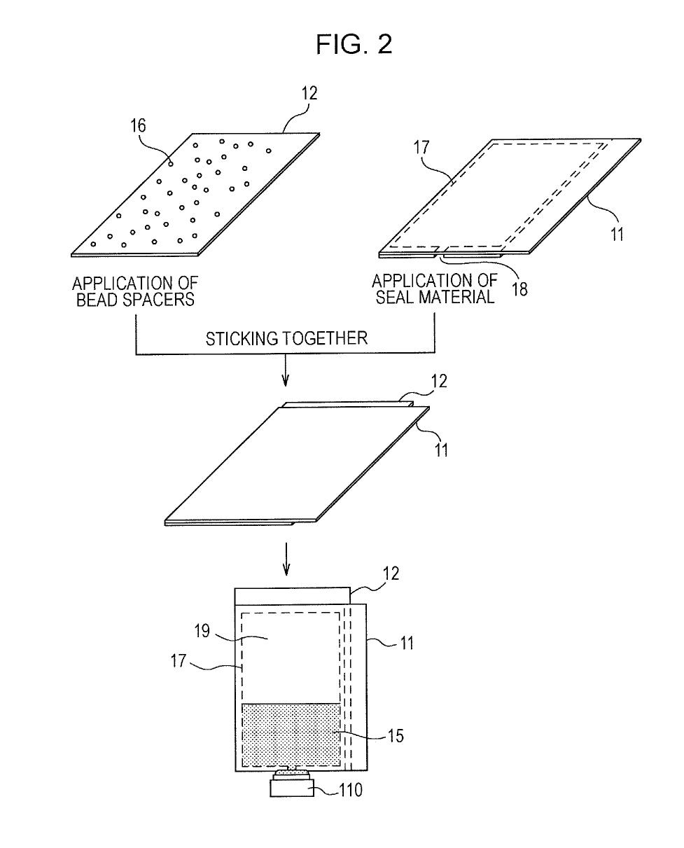

FIG. 2 is a diagram illustrating a method for manufacturing the liquid crystal display element in FIG. 1. After the layer 13 including the transparent electrodes, the alignment film, and the like is formed on the surface of the upper substrate 11, the seal material 17 is applied onto the layer 13. The seal material 17 is applied onto the peripheral portion of the upper substrate 11 so as to surround the inner side except a portion. The portion where no seal material is applied becomes the injection hole 18.

After the layer 14 including the transparent electrodes, the alignment film, and the like is formed on the surface of the lower substrate 12, the bead spacers 16 are applied onto the layer 14 with a predetermined density.

The upper substrate 11 and the lower substrate 12 are stuck together such that the layers 13 and 14 face each other.

Then, the stuck element is retained within a vacuum chamber and the vacuum chamber is evacuated. Thus, the cell space 19 of the element is also evacuated. In this state, the injection hole 18 is immersed into the liquid crystal 15 stored in a liquid crystal plate 110, and the vacuum state in the vacuum chamber is released, whereby the liquid crystal 15 is injected into the cell space 19 through the injection hole 18.

It is noted that there may also be a case where columnar structures (columnar spacers) are formed on a substrate by photolithography instead of the bead spacers 16 and then two substrates are stuck together.

As two substrates constituting a liquid crystal display element, glass substrates have been used, but in recent years, an element is developed in which flexible resin substrates (film substrates) are used instead of glass substrates. Such an element using film substrates is characterized in being bendable.

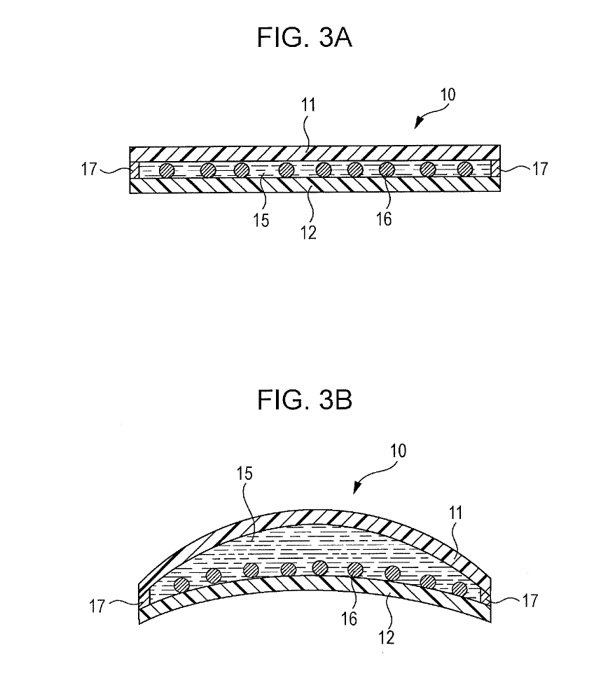

FIGS. 3A and 3B are diagrams illustrating cross sections of a bendable liquid crystal display element 10, in which the upper substrate 11 and the lower substrate 12 are formed as flexible film substrates, in a normal state and a bent state, respectively.

In the liquid crystal display element 10, the gap is uniform in the normal state as illustrated as FIG. 3A, but the gap becomes large at the central portion of the liquid crystal display element 10 as illustrated as FIG. 3B when being bent. As described above, in the case where the film substrates are used in the element having a structure using the bead spacers 16 or the columnar spacers, the gap between the two substrates may not be kept when the liquid crystal display element 10 is bent. Thus, when the liquid crystal display element 10 is bent, the liquid crystal greatly flows and a displayed image becomes distorted. Furthermore, in the case of a liquid crystal display element that is used for an electronic paper or the like and includes a cholesteric liquid crystal which maintains a bi-stable state even when no voltage is applied thereto, problems arise such as a displayed image not being able to be maintained.

Thus, columnar spacers having adhesiveness are used as spacers. When the columnar spacers having adhesiveness are used, even if the liquid crystal display element 10 is bent, the two substrates 11 and 12 are not separated from each other and the gap is kept.

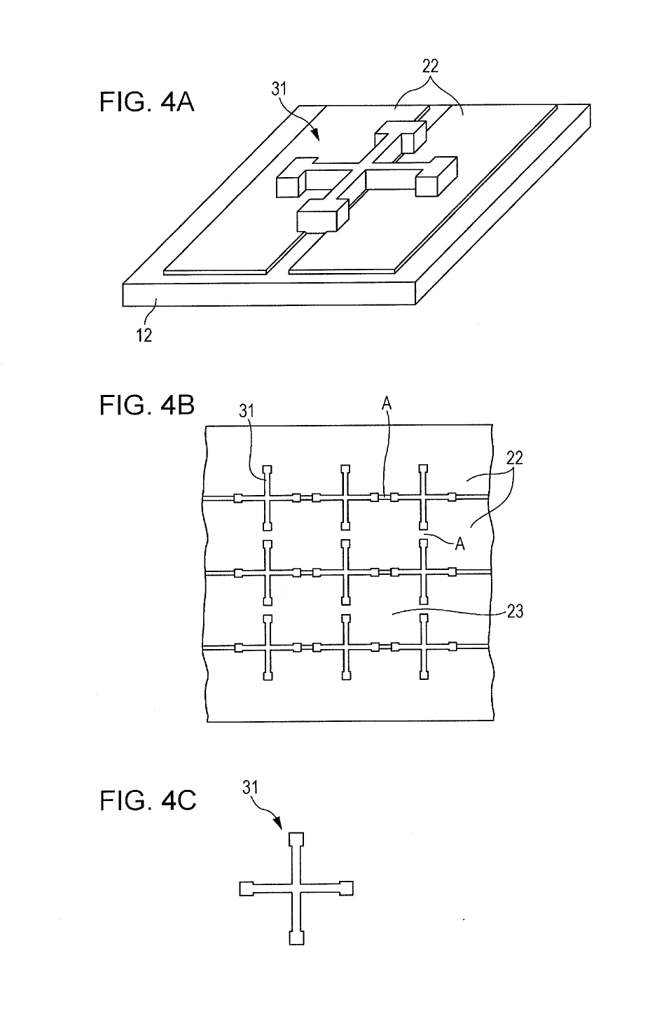

FIGS. 4A to 4C are diagrams illustrating an example of columnar spacers (spacer structures), FIG. 4A is a perspective view, FIG. 4B is a plan view, and FIG. 4C is an enlarged view of the columnar spacer 31. Even when not having adhesiveness, the columnar spacers 31 in FIGS. 4A to 4C can be used. However, the columnar spacers 31 will be described as ones having adhesiveness.

As illustrated as FIG. 4C, the columnar spacer 31 is thick at a portion of its wall in order to increase the stability of adhesion with the substrates. In a liquid crystal display element having a simple matrix structure, a plurality of strip electrodes are formed on two facing substrates so as to extend in two directions different from each other by 90 degrees, respectively, and a pixel is formed at each of portions where the strip electrodes intersect each other. As illustrated as FIGS. 4A and 4B, each columnar spacer 31 is arranged such that a straight portion thereof is located between lower strip electrodes 22 on the lower substrate 12 and another straight portion thereof is located between upper strip electrodes on the upper substrate 11 which is not shown. Therefore, each pixel 23 is surrounded by four columnar spacers 31, and four openings are formed between the adjacent columnar spacers 31. Thus, flow of the liquid crystal is limited and hence it is possible to reduce change in display. In addition, each pixel 23 is connected to adjacent pixels via the openings A between the adjacent columnar spacers 31 to be finally connected to the injection hole.

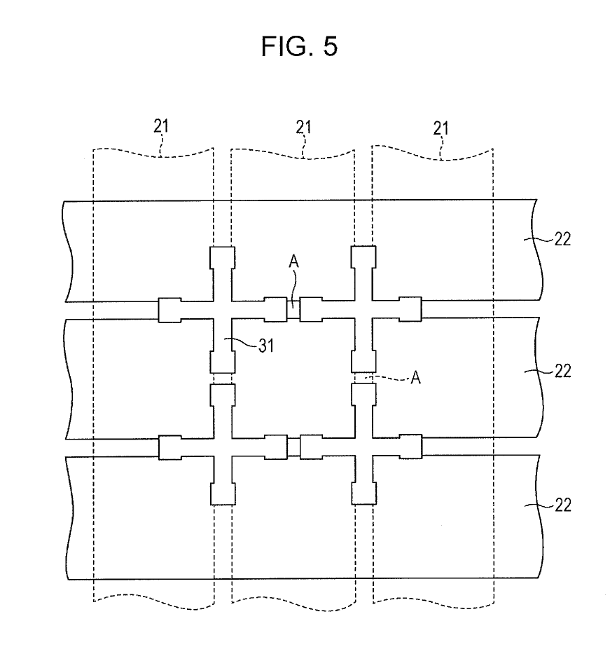

FIG. 5 is a diagram illustrating in detail the relationship between the columnar spacers 31 and the strip electrodes 21 and 22 on the upper and lower substrates 11 and 12. The columnar spacers 31 are arranged with respect to the strip electrodes 21 and 22 as illustrated as FIG. 5.

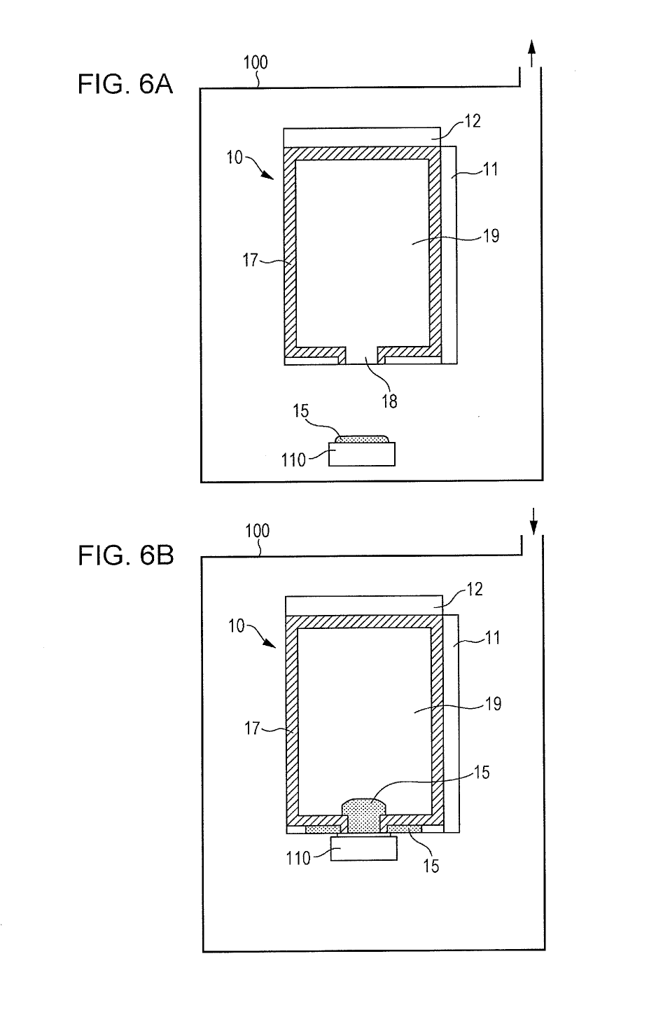

FIGS. 6A and 6B are diagrams explaining a vacuum pumping method and illustrate a case where a liquid crystal is injected into a liquid crystal panel by the vacuum pumping method.

After sticking, a process of cutting the side where the injection hole 18 is provided is conducted on the liquid crystal display element 10. Next, as illustrated as FIG. 6A, the liquid crystal display element 10 and the liquid crystal plate 110 in which the liquid crystal 15 is put are placed within a vacuum chamber 100. The liquid crystal display element 10 and the liquid crystal plate 110 are configured to be movable relative to each other within the vacuum chamber 100. Here, a description will be given on the assumption that the liquid crystal plate 110 is movable.

In this state, the vacuum chamber 100 is made into a vacuum state of, for example, about 0.13×10⁻² Pa (1×10⁻⁵ Torr). Accordingly, air within the cell space of the liquid crystal display element 10 is also sucked to the outside and the cell space is also made into a vacuum state.

Next, as illustrated as FIG. 6B, the liquid crystal plate 110 is moved to the injection hole 18, and the injection hole 18 is immersed into the liquid crystal 15 within the liquid crystal plate 110. Then, the vacuum chamber 100 is returned to normal pressure. By so doing, the liquid crystal 15 spreads into the cell space 19 due to capillarity. When the liquid crystal 15 spreads over the entire cell space 19, the injection hole 18 is moved away from the liquid crystal plate 110 and is sealed.

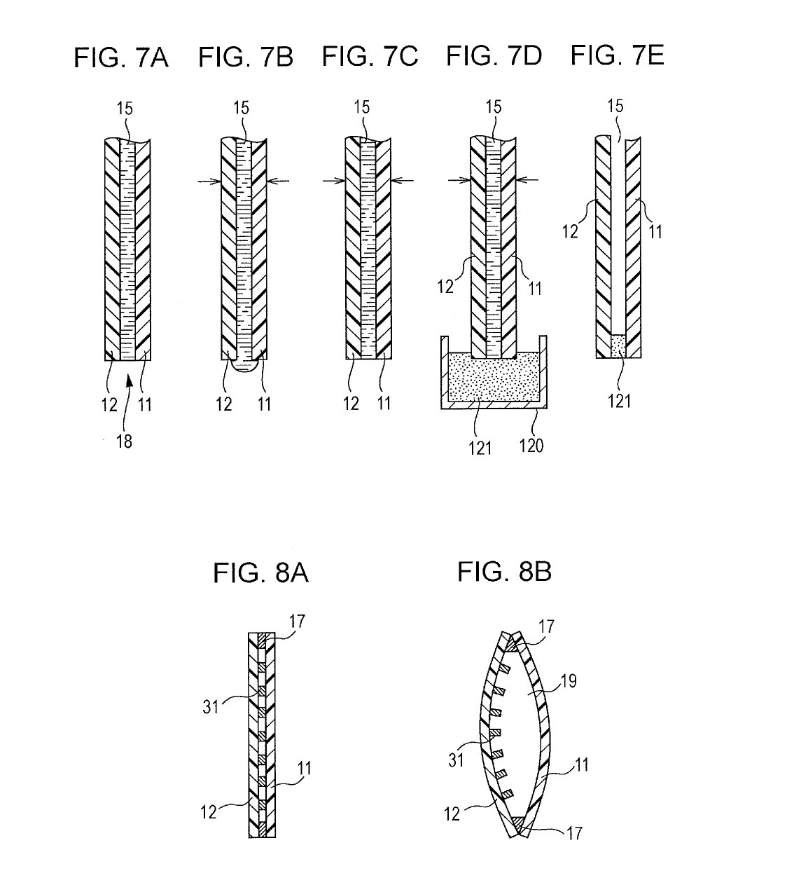

FIGS. 7A to 7E are diagrams explaining a method for sealing the injection hole 18.

As illustrated as FIG. 7A, in a cross section of the liquid crystal display element 10 which includes the end surface at the injection hole 18 of the liquid crystal display element 10 in which the liquid crystal 15 has been injected by the vacuum pumping method, the liquid crystal 15 is filled between the upper substrate 11 and the lower substrate 12. As illustrated as FIG. 7B, when pressure is applied to the upper substrate 11 and the lower substrate 12, the liquid crystal 15 is pushed out through the injection hole 18 in a small amount. When the pushed-out liquid crystal 15 is wiped off, it becomes the state illustrated as FIG. 7C. In this state, the injection hole 18 is immersed into a container 120 in which a sealant 121 is put, as illustrated as FIG. 7D. When the pressure applied to the upper substrate 11 and the lower substrate 12 is released, a small amount of the sealant 121 enters the injection hole 18 and it becomes the state illustrated as FIG. 7E. The sealant 121 is, for example, a thermosetting resin. By applying heat in the state of FIG. 7E, the sealant 121 is cured to close the injection hole 18.

FIGS. 8A and 8B are diagrams explaining a problem arising during injection of a liquid crystal by the vacuum pumping method in a case where the injection hole 18 is too narrow.

As illustrated as FIG. 8A, the two substrates 11 and 12 are adhered to each other by the columnar spacers 31, and the cell space 19 sealed except the injection hole 18 is formed by the seal material 17 at the peripheral portion between the two substrates 11 and 12.

As described above, when the liquid crystal display element 10 is put into the vacuum chamber 100 and the vacuum chamber 100 is changed into a vacuum state, air within the cell space 19 is exhausted through the injection hole 18. At that time, when the speed at which the air within the cell space 19 goes out through the injection hole 18 is lower than a speed at which air within the vacuum chamber 100 goes out since the injection hole 18 is too narrow, a state occurs in which the pressure in the cell space 19 is greater than the pressure in the vacuum chamber 100. In this state, due to the pressure difference between the cell space 19 and the vacuum chamber 100, a force acts to press the film substrates 11 and 12 toward the outer side. When the pressure difference is great, the film substrates 11 and 12 may be separated from the columnar spacers 31 such that the two film substrates 11 and 12 are formed in the shape of a bag, as illustrated as FIG. 8B. In such a state, the display element may not be restored and becomes a defective.

The width of the injection hole 18 is, for example, about 7 mm, and its height corresponds to the gap between the two film substrates 11 and 12 and is, for example, about 5 μm which is very small as compared to its width. Thus, in a process where the two film substrates 11 and 12 are stuck together or the like, the two film substrates 11 and 12 are stuck directly to each other at the injection hole 18 portion such that the opening of the injection hole 18 is narrowed and further closed.

For example, in the process where the two film substrates 11 and 12 are stuck together, the liquid crystal display element 10 is packed in vacuum, and a load is uniformly applied to the substrates 11 and 12 by the atmospheric pressure. However, the two film substrates 11 and 12 may bend at the injection hole 18 portion and may come into contact with each other to be stuck to each other.

Thus, it is proposed to provide bead spacers or columnar spacers at the injection hole 18 portion. The interval between spacers is determined such that even when the film substrates bend due to application of the atmospheric pressure in the process of sticking the two film substrates together, the two substrates do not come into contact with each other. For that reason, it is desirable to use columnar spacers which are formed by photolithography and can be regularly arranged. As columnar spacers used at the injection hole 18 portion, one having a circular or square shape when been seen from the direction perpendicular to the substrates, one having a shape obtained by connecting two squares, and one having an elongated shape of a long rectangular are proposed.

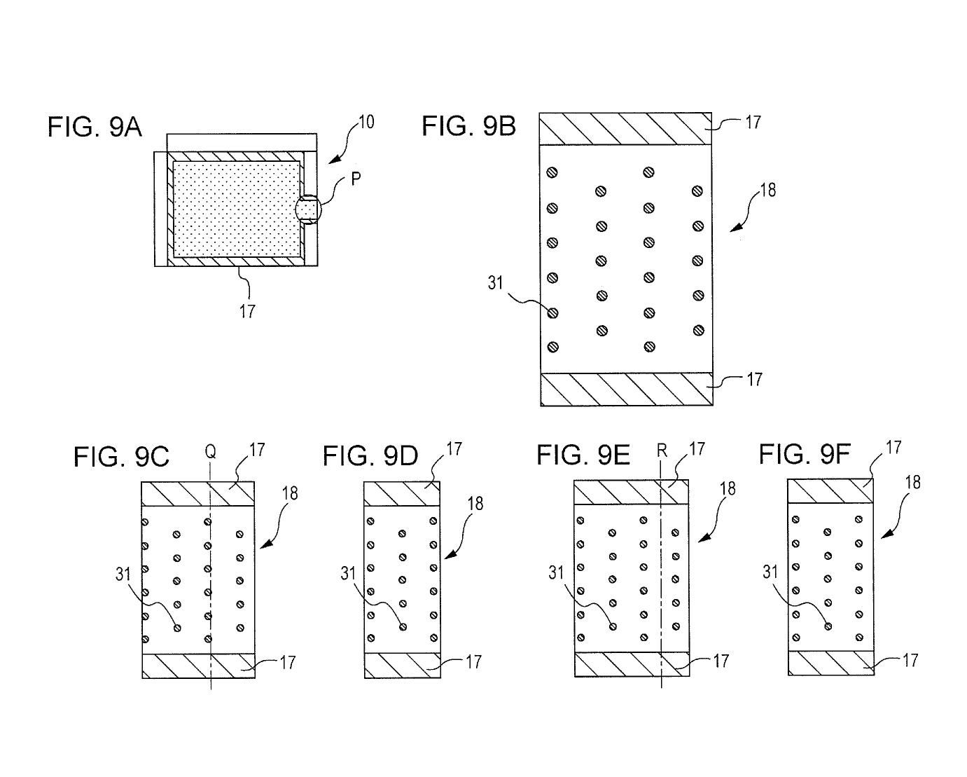

FIGS. 9A to 9F are diagrams explaining a problem arising in a case where spacers 31 each having a circular shape when been seen from the direction perpendicular to the substrates, namely, having a cylindrical shape, are regularly arranged at the injection hole 18 portion.

FIG. 9A is a diagram illustrating the position of the injection hole 18 in the liquid crystal display element 10, and the injection hole 18 is formed at a portion indicated by P.

FIG. 9B is an enlarged view of the injection hole 18 portion, the injection hole 18 is formed between the seal materials 17, and the cylindrical spacers 31 are regularly arranged at the injection hole 18 portion. There are a plurality of lines (here, four lines) in each of which the cylindrical spacers 31 are arranged at an equal interval (pitch), and adjacent lines are arranged so as to be shifted from each other by ½ of the pitch.

As described above, after the two film substrates 11 and 12 are stuck together, a process of cutting the side where the injection hole 18 is provided is conducted on the liquid crystal display element 10 to make the end surface of the injection hole 18 portion even. When cutting is conducted at a cutting position indicated by Q in FIG. 9C, a line of the cylindrical spacers 31 remains near the end surface as illustrated as FIG. 9D, and thus the injection hole 18 is not closed. On the other hand, when cutting is conducted at a cutting position indicated by R as in FIG. 9E, no line of the cylindrical spacers 31 is present near the end surface as illustrated as FIG. 9F. Thus, the two film substrates 11 and 12 are likely to bend at the portion of the end surface where the injection hole 18 is located, and hence the injection hole 18 is likely to be narrowed or closed.

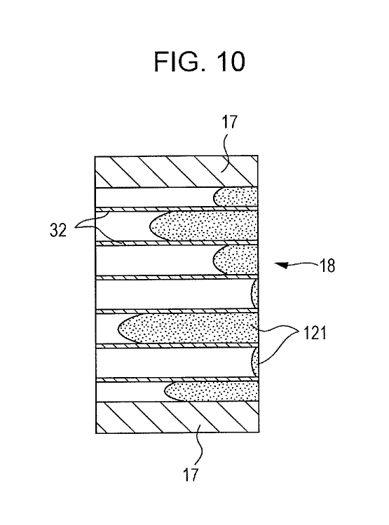

FIG. 10 is a diagram explaining an example and its problem of a plurality of columnar spacers that are proposed in order to alleviate closing of an injection hole by such bending of film substrates and that extend in a direction connecting the outside and a cell space and are arranged so as to be parallel to each other.

As illustrated as FIG. 10, a plurality of columnar spacers 32 are arranged at a predetermined interval in the injection hole 18 formed between the seal materials 17, so as to extend in a direction connecting the outside and the cell space, namely, in a direction parallel to the end surfaces of the seal materials 17 at the injection hole 18. The interval is determined such that even when the film substrates bend due to the atmospheric pressure being applied thereto in the process of sticking the two film substrates together, the two substrates do not come into contact with each other.

Even when the injection hole 18 in which the columnar spacers 32 in FIG. 10 are provided is cut at any position, the injection hole 18 is not closed in the process of injecting the liquid crystal, since the columnar spacers 32 extend to the cut surface. In addition, a plurality of paths in the injection hole 18 which are separated from each other by the plurality of columnar spacers 32 are connected to each other in the cell space, and thus do not particularly cause any problem in the process of injecting the liquid crystal.

As described above, in the process of sealing the injection hole 18, the injection hole 18 is immersed into the sealant 121 to be sealed. As illustrated as FIG. 10, the sealant 121 enters the plurality of paths in the injection hole 18 which are separated from each other by the plurality of columnar spacers 32. The plurality of columnar spacers 32 have errors in position and width and are different in their surface states from each other. Thus, the plurality of paths are not uniform and a state where the sealant 121 enters is different for each path. In other words, in the case where a plurality of columnar spacers 32 are provided as illustrated as FIG. 10, the sealant 121 is not uniformly drawn into the injection hole 18.

It is desirable that the sealant 121 stays in the injection hole 18 and does not enter the cell space 19. Thus, the injection hole 18 is immersed into the sealant 121 for a period of time within which the sealant 121 does not enter the cell space 19 even through a path into which the sealant 121 is most easily drawn, among the plurality of paths in the injection hole 18 which are separated from each other by the plurality of columnar spacers 32. In this case, as in FIG. 10, there is a path in which a small amount of the sealant 121 is drawn. When the sealant 121 is cured in this state, the liquid crystal 15 is likely to leak through the path to cause breakdown of the liquid crystal display element.

The structure, the manufacturing method, and the problems of the general liquid crystal display element have been described. An liquid crystal display element of an embodiment described below has a structure similar to that of the above general liquid crystal display element and is manufactured by a manufacturing method similar to that of the above general liquid crystal display element, but is different from the above general liquid crystal display element in the shapes and arrangement of columnar spacers at the injection hole 18 portion. For example, the liquid crystal display element of the embodiment has a rectangular shape with a long side of 175 mm and a short side of 132 mm and has an injection hole with a width of 7 mm at the short side. Upper and lower substrates 11 and 12 are made of polycarbonate with a thickness of 125 μm, and the thickness of a liquid crystal layer, namely, the interval (gap) between the upper and lower substrates 11 and 12 is 5 μm. In addition, a liquid crystal 15 is a cholesteric liquid crystal which is used for an electronic paper and maintains a bi-stable state even when no voltage is applied thereto.

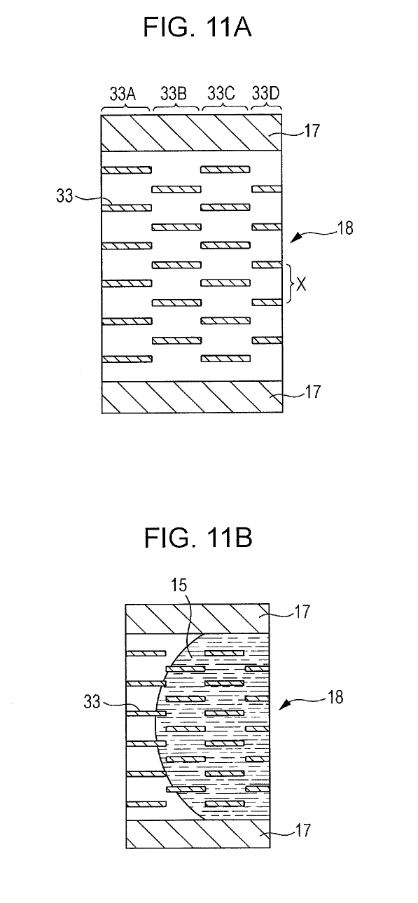

FIGS. 11A and 11B are diagrams illustrating the shapes and arrangement of columnar spacers at the injection hole 18 portion of the liquid crystal display element of the embodiment.

As illustrated as FIG. 11A, a plurality of columnar spacers 33 are arranged in the injection hole 18 formed between the seal materials 17. The plurality of columnar spacers 33 each have an extending shape to extend in a direction connecting the outside and the cell space (a direction perpendicular to the end surface at the injection hole 18 with respect to the outside), namely, in a direction parallel to the end surfaces of the seal materials 17 at the injection hole 18. The plurality of columnar spacers 33 are divided into a plurality of groups 33A, 33B, 33C, and 33D on the basis of their positions in the extending direction, a plurality of the columnar spacers 33 in each group have the same length and are arranged at a predetermined pitch so as to be parallel to each other. Pluralities of the columnar spacers 33 in the groups 33A and 33C are arranged so as to be shifted by ½ pitch relative to pluralities of the columnar spacers 33 in the groups 33B and 33D in a direction perpendicular to the extending direction. The lengths of the columnar spacers 33 are, for example, 100 to 200 μm, and their widths are, for example, about 10 μm.

The predetermined pitch at which the columnar spacers 32 are arranged is determined such that even when the atmospheric pressure is applied to the two film substrates 11 and 12, the two substrates 11 and 12 do not come into contact with each other. Specifically, a bending amount Wmax when film substrates (e.g., made of polycarbonate) having a Young's modulus E and a thickness t (e.g., 125 μm) are fixed to a frame having a length a of a short side and a length b of a long side and a load q is applied thereto is represented by the following equation.

Wmax=αqb⁴/Et³

Here, α is a coefficient.

Since the interval (gap) between the two substrates 11 and 12 is 5 μm, if the two substrates bend by 2.5 μm, the two substrates come into contact with each other. Thus, when Wmax=2.5 μm, q is the atmospheric pressure, and α, E, and t are set in accordance with the material, b can be calculated, and the calculated b is set as a maximum pitch. The arrangement pitch of the columnar spacers 33 is set so as to be equal to or less than the maximum pitch. However, if the arrangement pitch is too small, the air in the cell space is unlikely to come out, and burst of the element occurs as illustrated as FIG. 8B. Thus, the arrangement pitch of the columnar spacers 33 is preferably set as appropriate also in view of a depressurization rate of the vacuum chamber in the process of injecting the liquid crystal 15.

It is noted that FIG. 11A illustrates that the group 33A has six columnar spacers 32, the width of the injection hole 18 is about 7 mm, and the number of columnar spacers 33 is set in accordance with the determined arrangement pitch of the columnar spacers 33. In addition, in FIG. 11A, four groups of columnar spacers having lengths of 100 to 200 μm are provided, but it is desirable to set the number of groups as appropriate in accordance with the length of the injection hole 18, and it is desirable to provide columnar spacers 33 over a range of at least 0.7 mm or more in the extending direction from the end surface at the injection hole 18 with respect to the outside.

As described above, after the two film substrates 11 and 12 are stuck together, a process of cutting the side at which the injection hole 18 is provided is conducted on the liquid crystal display element 10 to make the end surface of the injection hole 18 portion even. The accuracy of the cutting position of a cutting device is normally about ±100 μm. Thus, with the shapes and arrangement of the columnar spacers 33 illustrated as FIG. 11, the injection hole 18 is not closed even if the cutting position slightly shifts.

Furthermore, the columnar spacers 33 are divided into a plurality of groups on the basis of their positions in the extending direction, and the columnar spacers 33 in the adjacent groups are shifted from each other by ½ of the arrangement pitch. The paths separated from each other by the columnar spacers 33 are each connected to two paths in the subsequent group. Thus, even if the amount of the drawn sealant 121 is different between the individual paths, the drawn amounts are averaged. Thus, the sealant 121 is evenly drawn over the entire injection hole 18. Because of this, leak or the like of the liquid crystal 15 is unlikely to occur.

As described above, the lengths and arrangement pitch of the columnar spacers 33 are set as appropriate, but there can be various modified examples for the shapes and arrangement of the columnar spacers. Some of them will be described below.

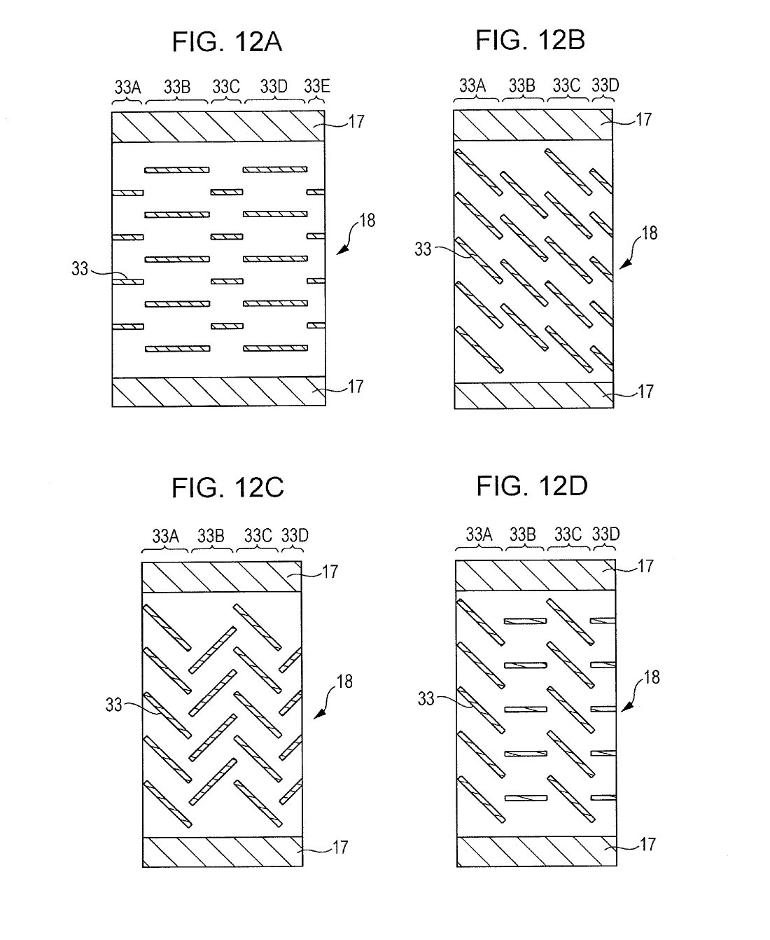

FIGS. 12A to 12D are diagrams illustrating modified examples of the shapes and arrangement of the columnar spacers.

In FIG. 12A, the columnar spacers 33 each have an extending shape to extend in the direction connecting the outside and the cell space and are divided into a plurality of groups 33A to 33E on the basis of their positions in the extending direction, and their lengths in the extending direction are different between the groups. Specifically, the columnar spacers 33 in the groups 33A, 33C, and 33E are short, and the columnar spacers 33 in the groups 33B and 33D are long. The columnar spacers 33 are arranged in each group at a predetermined pitch in a direction perpendicular to the extending direction, and are arranged in the adjacent groups so as to be shifted from each other by ½ pitch.

In FIG. 12B, the columnar spacers 33 each have an extending shape to extend in a direction tilted at 45 degrees relative to the direction connecting the outside to the cell space and are divided into a plurality of groups 33A to 33E on the basis of their positions in the direction connecting the outside and the cell space. Except for the group at the edge, regardless of the groups, the lengths of the columnar spacers 33 in the extending direction are the same. The columnar spacers 33 are arranged in each group at a predetermined pitch in a direction perpendicular to the direction connecting the outside and the cell space, and are arranged in the adjacent groups so as to be shifted from each other by ½ pitch.

In FIG. 12C, the shapes and arrangement of the columnar spacers 33 are as in FIG. 12B, but the extending direction of the columnar spacers 33 is changed between the adjacent groups. The columnar spacers 33 in the groups 33A and 33C each have an extending shape to extend in a direction tilted at +45 degrees relative to the direction connecting the outside and the cell space. On the other hand, the columnar spacers 33 in the groups 33B and 33D each have an extending shape to extend in a direction tilted at −45 degrees relative to the direction connecting the outside and the cell space. In other words, the extending directions of the columnar spacers 33 in the groups 33A and 33C are different from those of the columnar spacers 33 in the groups 33B and 33D by 90 degrees. Except for the group at the edge, regardless of the groups, the lengths of the columnar spacers 33 in the extending direction are the same. The columnar spacers 33 are arranged in each group at a predetermined pitch in a direction perpendicular to the direction connecting the outside and the cell space, and are arranged in the adjacent groups so as to be shifted from each other at their ends by ½ pitch.

In FIG. 12D, the shapes and arrangement of the columnar spacers 33 are as in FIG. 12B, but the extending direction of the columnar spacers 33 is changed between the adjacent groups. The columnar spacers 33 in the groups 33A and 33C each have an extending shape to extend in a direction tilted at +45 degrees relative to the direction connecting the outside and the cell space. On the other hand, the columnar spacers 33 in the groups 33B and 33D each have an extending shape to extend in the direction connecting the outside and the cell space. In other words, the extending directions of the columnar spacers 33 in the groups 33A and 33C are different from those of the columnar spacers 33 in the groups 33B and 33D by 45 degrees. Except for the group at the edge, regardless of the groups, the lengths of the columnar spacers 33 in the extending direction are the same. The columnar spacers 33 are arranged in each group at a predetermined pitch in a direction perpendicular to the direction connecting the outside and the cell space, and are arranged in the adjacent groups so as to be shifted from each other at their ends by ½ pitch.

With the shapes and arrangements of the columnar spacers in FIGS. 12A to 12D, the same advantageous effects as in FIGS. 11A and 11B are obtained.

Although the modified examples have been described above, a person skilled in the art can easily understand that there can be other various modified examples.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A liquid crystal display element comprising:
a flexible first substrate and a flexible second substrate;
an inter-substrate spacer structure that bonds the first substrate and the second substrate and keeps a space between the first substrate and the second substrate at a certain interval;
a seal material that seals a surrounding area between the first substrate and the second substrate to form a cell space;
a liquid crystal that is injected in the cell space; and
an injection hole that is formed between the first substrate and the second substrate for injecting the liquid crystal from an outside into the cell space and includes an injection hole spacer structure that keeps the space between the first substrate and the second substrate at a certain interval, the injection hole spacer structure including a plurality of lines which each line includes of a plurality of extending structures that are arranged such that extending directions of the plurality of extending structures are parallel to each other when the plurality of extending structures are seen from a direction perpendicular to the first and second substrates,
wherein in each line, the plurality of extending structures are arranged at a certain interval, and
the plurality of extending structures in adjacent lines are arranged such that the extending direction of the plurality of extending structures in one of the lines does not overlap the extending direction of the plurality of extending structures in the other line.

2. The liquid crystal display element according to claim 1, wherein each of ends of the extending structures in one line is located at an intermediate position between adjacent ends of the plurality of extending structures in the adjacent line.

3. The liquid crystal display element according to claim 2, wherein
the extending structures in the plurality of lines have the same extending direction and the pre-defined intervals are the same, and
the extending structures in adjacent lines are arranged so as to be shifted from each other by ½ of the predetermined interval.

4. The liquid crystal display element according to claim 3, wherein the extending structures between adjacent lines have different lengths in the extending direction with each other.

5. The liquid crystal display element according to claim 3, wherein the extending directions of the extending structures in the plurality of lines are perpendicular to a surface where the injection hole contacts the outside.

6. The liquid crystal display element according to claim 3, wherein the extending directions of the extending structures in the plurality of lines are tilted by 45 degrees or less relative to a direction perpendicular to a surface where the injection hole contacts the outside.

7. The liquid crystal display element according to claim 2, wherein the extending structures between adjacent lines have different extending directions with each other.
